(19) United States
(12) Patent Application Publication
(10) Pub. No.: US 2011/0148774 A1
(43) Pub. Date: Jun. 23, 2011

(54) Handling Tactile Inputs

(75) Inventor: Pekka Juhana PIHLAJA, Hevonpaa (FI)

(73) Assignee: Nokia Corporation

(21) Appl. No.: 12/645,703

(22) Filed: Dec. 23, 2009

(51) Int. Cl. G06F 3/041

(52) U.S. Cl. 345/173

(57) ABSTRACT

Apparatus includes at least one processor configured, under the control of machine-readable code: to receive from a touch sensitive transducer signals indicative of a detected dynamic tactile input incident on the touch sensitive transducer; to determine based on the signals received from the touch sensitive transducer a direction of an initial movement of a detected dynamic tactile input; and to provide control signals for causing an indicator, the indicator being for indicating to a user a currently highlighted one of an array of images displayed on a display panel, to be moved in a direction corresponding to the direction of the initial movement from a first image of the array of images to a second image of the array of images, the second image directly neighboring the first image, said indicator being moveable from a currently highlighted image to images directly neighboring the currently highlighted image.

### FIELD

The invention relates to an apparatus and a method for receiving signals indicative of a detected dynamic tactile input incident on a touch sensitive transducer.

### BACKGROUND

User interfaces, such as touchscreens, have become commonplace since the emergence of the electronic touch interface. Touchscreens have become familiar in retail settings, on point of sale systems, on smart phones, on automated teller machines (ATMs), and on personal digital assistants (PDAs). The popularity of smart phones, PDAs, and other types of handheld electronic device has resulted in an increased demand for touchscreens

### SUMMARY

A first aspect of the specification describes apparatus comprising at least one processor configured, under the control of machine-readable code: to receive from a touch sensitive transducer signals indicative of a detected dynamic tactile input incident on the touch sensitive transducer; to determine based on the signals received from the touch sensitive transducer a direction of an initial movement of a detected dynamic tactile input; and to provide control signals for causing an indicator, the indicator being for indicating to a user a currently highlighted one of an array of images displayed on a display panel, to be moved in a direction corresponding to the direction of the initial movement from a first image of the array of images to a second image of the array of images, the second image directly neighboring the first image, said indicator being moveable from a currently highlighted image to images directly neighboring the currently highlighted image.

The apparatus may further comprise: a display panel configured to display the array of images and to display the indicator for indicating to a user a currently highlighted one of the array of images, said indicator being moveable from a currently highlighted image to images directly neighboring the currently highlighted image; and a touch sensitive transducer having a touch sensitive area, the touch sensitive transducer being configured to detect dynamic tactile inputs incident on the touch sensitive area. The apparatus may further comprise a non-visual output transducer configured to output non-visual signals to a user. The apparatus may further comprise a display panel configured to display plural arrays of images and to display at least one of the arrays an indicator indicating to a user a currently highlighted one of the respective array of images, said indicator being moveable from a currently highlighted image on the respective array to images directly neighboring the currently highlighted image on the respective array. The touch sensitive area may comprise plural regions, each of the plural regions corresponding to a respective one of the plural arrays and wherein the at least one processor may be configured: to determine to which one of the plural regions the detected dynamic tactile input is incident; to determine a direction of an initial movement of the detected dynamic tactile input; and to cause said indicator to be moved in a direction corresponding to the first direction of movement from a first image in the array corresponding to the region to which the detected dynamic tactile input is incident to second image in the array, the second image in the array directly neighboring the first image in the array.

The specification also describes apparatus comprising: means for receiving from a touch sensitive transducer signals indicative of a detected dynamic tactile input incident on the touch sensitive transducer; means for determining, based on the signals received from the touch sensitive transducer, a direction of an initial movement of the detected dynamic tactile input; and means for providing control signals for causing an indicator, the indicator being for indicating to a user a currently highlighted one of an array of images, to be moved in a direction corresponding to the direction of the initial movement from a first image in the array of images to a second image in the array of images, the second image directly neighboring the first image, said indicator being moveable from a currently highlighted image to images directly neighboring the currently highlighted image. The apparatus may further comprise: means for displaying the array of images and for displaying the indicator for indicating to a user a currently highlighted one of the array of images, said indicator being moveable from a currently highlighted image to images directly neighboring the currently highlighted image; and means for detecting dynamic tactile inputs. The apparatus may further comprise means for outputting non-visual signals to a user.

A second aspect of the specification describes a method comprising: receiving from a touch sensitive transducer signals indicative of a detected dynamic tactile input incident on the touch sensitive transducer; determining, based on the signals received from the touch sensitive transducer, a direction of an initial movement of the detected dynamic tactile input; providing control signals for causing an indicator, the indicator being for indicating to a user a currently highlighted one of an array of images, to be moved in a direction corresponding to the direction of the initial movement from a first image in the array of images to a second image in the array of images, the second image directly neighboring the first image, said indicator being moveable from a currently highlighted image to images directly neighboring the currently highlighted image.

A third aspect of the specification describes a non-transitory computer-readable storage medium having stored thereon computer-readable code, which, when executed by computer apparatus, causes the computer apparatus: to receive from a touch sensitive transducer signals indicative of a detected dynamic tactile input incident on the touch sensitive transducer; to determine, based on the signals received from the touch sensitive transducer, a direction of an initial movement of the detected dynamic tactile input; and to provide control signals for causing an indicator, the indicator being for indicating to a user a currently highlighted one of the array of images, to be moved in a direction corresponding to the direction of the initial movement from a first image in the array of images to a second image in the array of images, the second image directly neighboring the first image, said indicator being moveable from a currently highlighted image to images directly neighboring the currently highlighted image.

The methods described herein may be caused to be performed by computing apparatus executing computer readable code.

### BRIEF DESCRIPTION OF THE DRAWINGS

For a more complete understanding of exemplary embodiments of the present invention, reference is now made to the following description taken in connection with the accompanying drawings in which:

FIG. 1 is a block diagram of electronic apparatus according to exemplary embodiments of the present invention;

FIG. 2 shows an electronic device according to exemplary embodiments of the invention;

FIGS. 3A to 3D shows the electronic device of FIG. 2 at various stages throughout an operation according to exemplary embodiments of the present invention;

FIG. 4 is a flow diagram showing an operation of the apparatus of FIG. 1 according to exemplary embodiments of the invention;

FIG. 5 is a view of an array displayed on the device of FIG. 2 according to exemplary embodiments of the invention; and

FIG. 6 shows the electronic device of FIG. 2 according to alternative exemplary embodiments of the invention.

### DETAILED DESCRIPTION OF THE EMBODIMENTS

In the description and drawings, like reference numerals refer to like elements throughout.

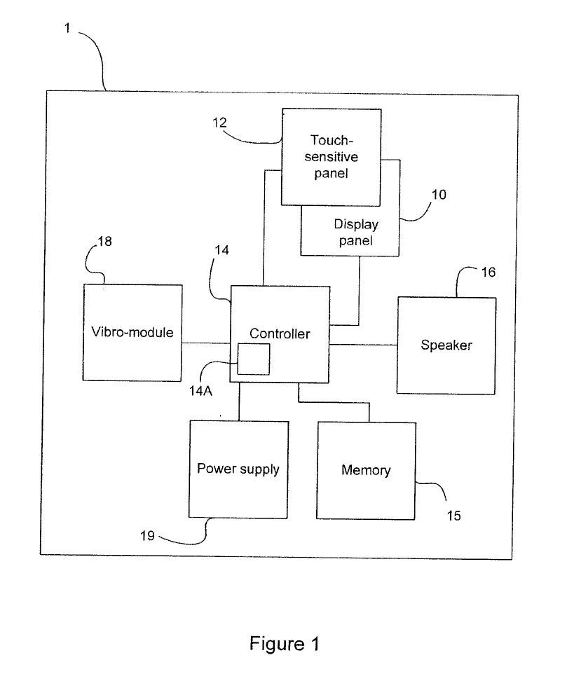

FIG. 1 is a simplified schematic of electronic apparatus 1 according to exemplary embodiments of the present invention. The electronic apparatus 1 comprises a display panel 10, a touch-sensitive transducer 12 and a controller 14. The controller 14 is configured to receive from the touch-sensitive panel 12 signals indicative of tactile inputs incident on the touch-sensitive transducer 12. The controller 14 is configured also to control the output of the display panel 10. The controller 14 includes one or more processors 14A operating under the control of computer readable code optionally stored on a non-transitory memory medium 15 such as ROM or RAM. The controller 14 may also comprise one or more application-specific integrated circuits (ASICs) (not shown).

The exemplary electronic apparatus 1 also comprises one or more non-visual output transducers 16, 18 for providing non-visual feedback to a user. In the example of FIG. 1, the electronic apparatus 1 comprises a speaker 16 and a vibration module 18. The controller 14 is further configured to control the speaker 16 and the vibration module 18.

The exemplary electronic apparatus 1 also comprises a power supply 19 configured to provide power to the other components of the electronic apparatus 1. The power supply 19 may be, for example, a battery or a connection to a mains electricity system. Other types of power supply 19 may also be suitable.

As will be understood from the following description, the electronic apparatus 1 may be provided in a single electronic device 2, or may be distributed.

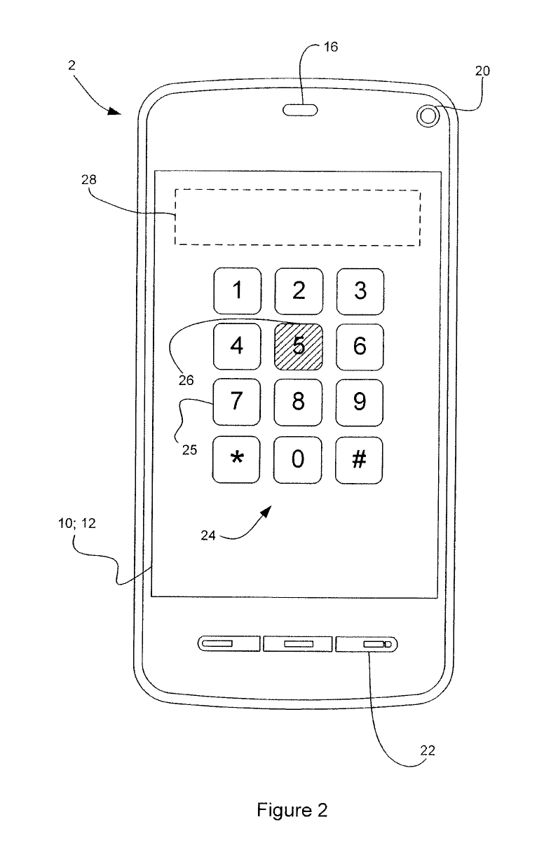

FIG. 2 shows an electronic device 2 according to exemplary embodiments of the present invention. The electronic device 2 comprises the electronic apparatus 1 described with reference to FIG. 1. In this example, the electronic device 2 is a mobile telephone 2. However, it will be understood that the electronic device 2 alternatively may be a PDA, a positioning device (e.g. a GPS module), a music player, a game console, a computer or any other type of touch screen electronic device 2. In the example of FIG. 2, the electronic device 2 is a portable electronic device. However, it will be understood that the invention is applicable to non-portable devices.

The mobile telephone 2 may comprise, in addition to those components described with reference to FIG. 1, other elements such as, but not limited to, a camera 20, depressible keys 22, a microphone (not shown), an antenna (not shown) and transceiver circuitry (not shown).

In the mobile telephone 2 of the example of FIG. 2, the touch-sensitive transducer is 12 is a touch-sensitive panel 12 and is overlaid on the display panel 10 to form a touch-sensitive screen 10, 12, or touchscreen. Displayed on the touch screen 10, 12 is an array 24 of selectable icons 25 or images 25. In this example, the array 24 of images 25 is a virtual ITU-T number pad. The number pad 24 comprises icons 25 representing the numbers 0 to 9, and * and # inputs. The number pad 24 allows a user to enter a telephone number. Also displayed on the touchscreen 10, 12 is an indicator 26. The indicator 26 provides to a user an indication of a currently selected icon 25. The indicator 26 may comprise a cursor, a highlighted region, or any other suitable means for visually indicating a currently selected icon 25. In the example of FIG. 2, the indicator 26 is represented by parallel line shading. The indicator 26 may be an icon 25 the same as the icon at the location of the indicator but with different lighting or coloring and/or being in a different size. The indicator 26 may change in appearance over time, for instance by appearing to vary in brightness in a cyclical pattern. Prior to receiving touch input, the indicator 26 may by default be provided at the same one of the array 24 of selectable icons, in this example the “5 key”. Thus, the indicator 26 is provided at one of the centre most icons 25 in the array. By providing the indicator 26 at one of the centermost icons 25, the average distance to each of the other icons 25 is minimized. According to alternative embodiments, the indicator 26 may instead be provided at another location, for example at the top left icon 25 of the array.

In the example of FIG. 2, also displayed on the touchscreen 10, 12 is a display region 28 for displaying the numbers selected by the user. It will be understood that according to alternative examples, in which the array 24 is a menu, with each of the icons 25 representing, for example, an executable application or a selectable item, the display region 28 may be omitted.

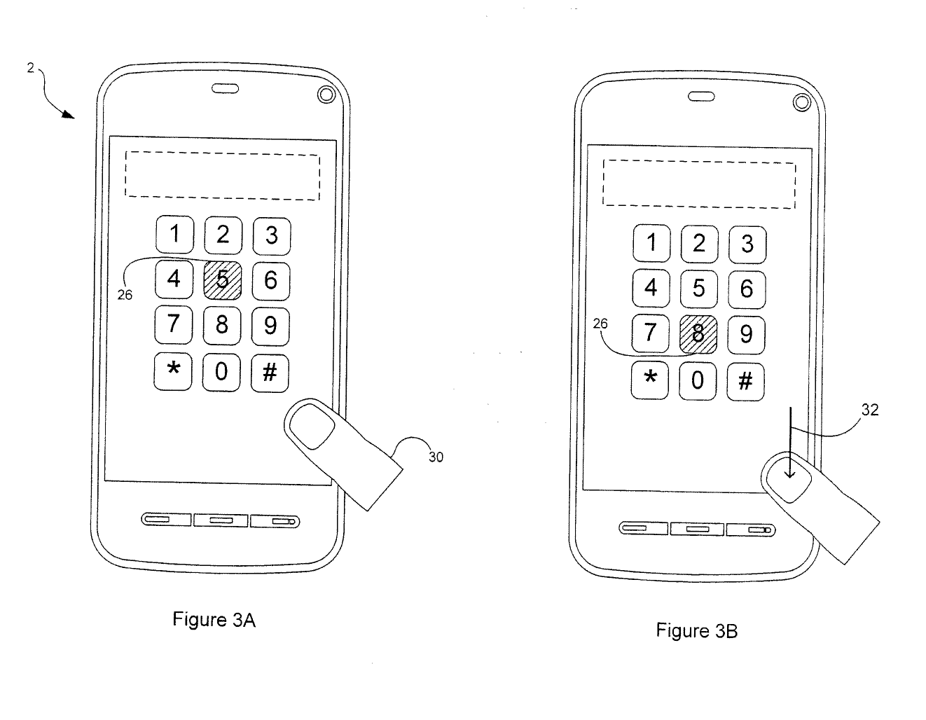

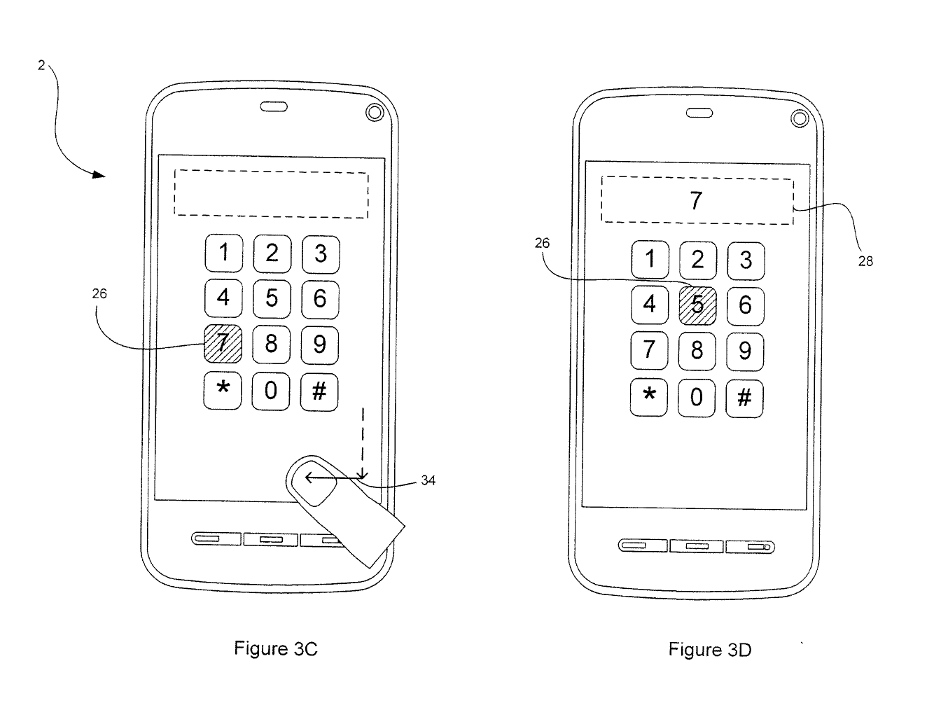

An exemplary operation of the electronic device 2 of FIG. 2 will now be described with reference to FIGS. 3A to 3D. FIGS. 3A to 3D depicts the electronic device 2 of FIG. 2 at various stages throughout the operation.

In FIG. 3A, a tactile input, in this case from a user's finger 30, is incident on the touchscreen 10, 12. A tactile input may include the provision of a finger, thumb or stylus at any location on the surface of the touch sensitive panel 12. Next, in FIG. 3B the finger 30 of the user is slid or otherwise moved along the surface of the touchscreen 10, 12. This type of tactile input can be known as a dynamic tactile input.

In the example of FIG. 3B, the initial movement 32 of the dynamic tactile input is in the downwards direction. In response to detecting that the dynamic tactile input is in the downwards direction, the indicator 26 is caused to be moved to the neighboring icon 25 in the downwards direction, in this example, to the “8 key”.

Next, as shown in FIG. 3C, the user continues the dynamic tactile input by moving their finger 30 in a second direction along the surface of the touchscreen 10, 12. In this example, the second direction 34 is leftwards. In response to detecting a movement of the dynamic tactile input in the leftwards direction, the indicator 26 is caused to be moved from its previous location (the “8 key”) to a neighboring icon 25 in a direction corresponding to that of the movement of dynamic tactile input (i.e. the leftwards directions), in this example the “7 key”.

Finally, in the example of FIG. 3D, the user completes or terminates the dynamic tactile input by removing their finger 30 from the touchscreen 10, 12. In response to detecting the completion of the dynamic tactile input, an action associated with the currently selected icon, in this case the “7 key”, is caused to be performed by the controller 14. Thus, a number seven is displayed on the display region 28. Following completion of the dynamic tactile input, the indicator 26 is caused to be returned to its initial location, in this example, the “5 key”.

According to alternative exemplary embodiments, completion of the dynamic tactile input may be detected when a touch input has remained stationary for a predetermined duration of time. Also, according to other alternative exemplary embodiments in which the touch sensitive display has an associated force sensor (not shown), completion of a touch input may be detected when it is detected that a user applies the tactile input with force of greater than a threshold level, or when the incident force is detected to have increased by more than a predetermined amount or at more than a predetermined rate. According to these embodiments, the user may cause a currently highlighted one of the icons 25 to be selected by increasing the force with which they are touching the surface of the touch-sensitive display 10, 12. According to yet other exemplary embodiments, completion of the dynamic tactile input may be detected when one or more taps (or other gesture) of the user's finger on the display 10, 12 is detected. According to these exemplary embodiments, the user may cause the indicator to be moved about the array by sliding their finger about the surface of the display and may cause the currently highlighted of the icons 25 to be selected by providing one or more taps to the surface of the touch-sensitive display 10, 12,

From FIGS. 3A to 3D, it will be understood that by providing the appropriate dynamic tactile input, the user is able to cause the indicator 26 to be moved from one icon 25 to one or more neighboring icons, until the required icon 25 is reached. At this point, the user removes their finger 30 from the touchscreen 10, 12 and an action associated with the icon 25 is caused to be performed. The actions may include for example, when the array 24 of icons 25 is an operating menu, execution of an application.

A tactile input may be a dynamic tactile input when a user's finger, thumb or stylus 30 is moved across in continuous contact with the surface of the touch-sensitive panel 12 by more than a threshold distance. Movement of the finger 30 by less than a threshold distance may not constitute a dynamic tactile input, instead constituting a stationary input. A dynamic tactile input may include movements in a number of different directions. The movements may be in one continuous motion or may be in more than one discontinuous motion. A dynamic tactile input may last for as long as the user's finger is in contact with the surface of the touch sensitive panel. Alternatively, the dynamic tactile input may finish while a user's finger remains in contact with the touch sensitive panel but is stationary for longer than a predetermined duration.

In this example, the starting and finishing locations of the dynamic tactile input are not critical. For example, according to some exemplary embodiments, the tactile input may begin and/or end on an area of the touch-sensitive display 10, 12 that does not correspond to the array 24. More important is the way in which the dynamic tactile input gets from its starting point to its finishing point. Thus, unlike in conventional touch screen systems, there is no requirement physically to touch the icon 25 that is required to be selected. Instead, in one exemplary embodiment the movement of the indicator 26 is synchronized with the detected movement of the dynamic tactile input. As such, the icons 25 may be smaller than in conventional touchscreen systems and so more icons 25 can be provided on a display.

According to some exemplary embodiments, non-visual feedback may be associated with the movement of the indicator 26. For instance, as the indicator 26 moves from one icon 25 to a neighboring icon, feedback, for example a sound outputted by the speaker 16, or a vibration by the vibration module 18, may be provided to the user. In this way, an indication of the movement of the indicator 26 may be provided to the user, without the need for the user to look at the touchscreen 10, 12.

Different types of feedback may be associated with movement of the indicator 26 in different directions. For example, a first type of feedback, such as a first sound, may be associated with movement in a horizontal direction and a second type of feedback, such as a second sound, may be associated with movement in a vertical direction. Similarly, a third type of feedback, for example a third sound, may be provided with movement in a diagonal direction. In this way, the user may be provided with an indication of not only the movement of the indicator, but also of the direction of movement of the indicator. Thus, the user may be able easily to calculate the current location of the indicator 26 without looking at the touchscreen 10, 12.

In one exemplary embodiment, if the indicator 26 is caused to be moved in a leftwards direction, for example from the “5 key” to the “4 key”, the indicator 26 may be unable to move any further in the left direction. The electronic device 2 may be further configured to cause the non-visual output transducer 16, 18 to provide a non-visual signal to the user if the user attempts to move the cursor in a disallowed direction. As such, when the indicator 26 is provided on an icon 25 at an edge of the array, and the user attempts to move the indicator 26 in a direction towards the edge, a fourth type of feedback, for example a fourth sound, may be provided.

According to alternative embodiments, the indicator 26 may instead be movable, in response to a leftwards movement of the tactile input, from an icon 25 at the left hand edge of an array 24 to an icon 25 on the right-hand edge of the array 24.

According to some exemplary embodiments, the vibration module 18, and the speaker 16 both may be used to provide feedback to the user. For example, the speaker 16 may be used to provide sounds indicating that the indicator 26 has moved from one icon 25 to a neighboring icon, and the vibration module 18 may be caused to vibrate the electronic device 2 if the user attempts to move the indicator 26 beyond the edge of the array.

By providing the indicator 26 at the same starting point by default, and by providing feedback of varying types to the user, the user may, once they have learnt the layout and location of various features on the array, move the cursor throughout the array 24 and select desired icons 25 without looking at the touchscreen 10, 12. This may be particularly advantageous to visually impaired users. It may be advantageous also to users whom need to be looking at something other than the touchscreen 10, 12, for instance when driving a vehicle.

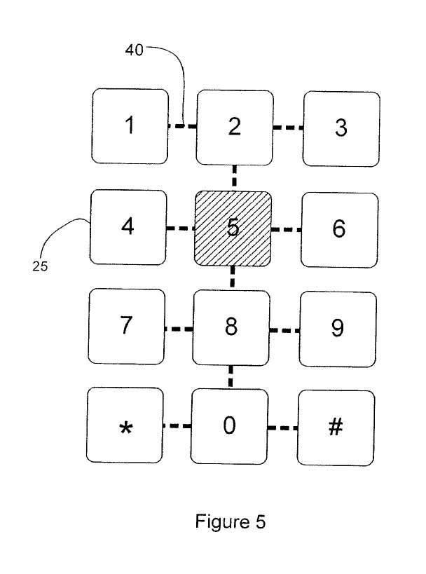

In some exemplary embodiments, the indicator 26 may be moveable throughout the array 24 only along certain predetermined paths 40. This can be seen illustrated on the example of FIG. 5. In FIG. 5 the paths 40 along which the indicator 26 can be moved are shown by the dashed lines connecting the icons 25. The allowed paths may be displayed on the screen. In this example, the indicator 26 is able to move to icons 25 in the left- or right-hand column only via the central icon 25 in the row. In this example, there is only one path 40 along which the indicator 26 can be moved to any one icon, with all other ways being prohibited.

Over time, the user may begin sub-consciously to associate a particular type of dynamic tactile input with selection of a particular icon 25. For example, the user may begin sub-consciously to associate the provision of a dynamic tactile input comprising an upwards movement followed by a leftwards movement with moving the indicator to the “1 key”. In this way, the user may become able to select the any of the icons 25 without having to look at the screen. It will be appreciated that the configuration of the predetermined paths 40 may be different to that shown in FIG. 5. For example, the predetermined paths 40 may be such that the icons 25 in the left and right hand columns may be accessed only via the top row.

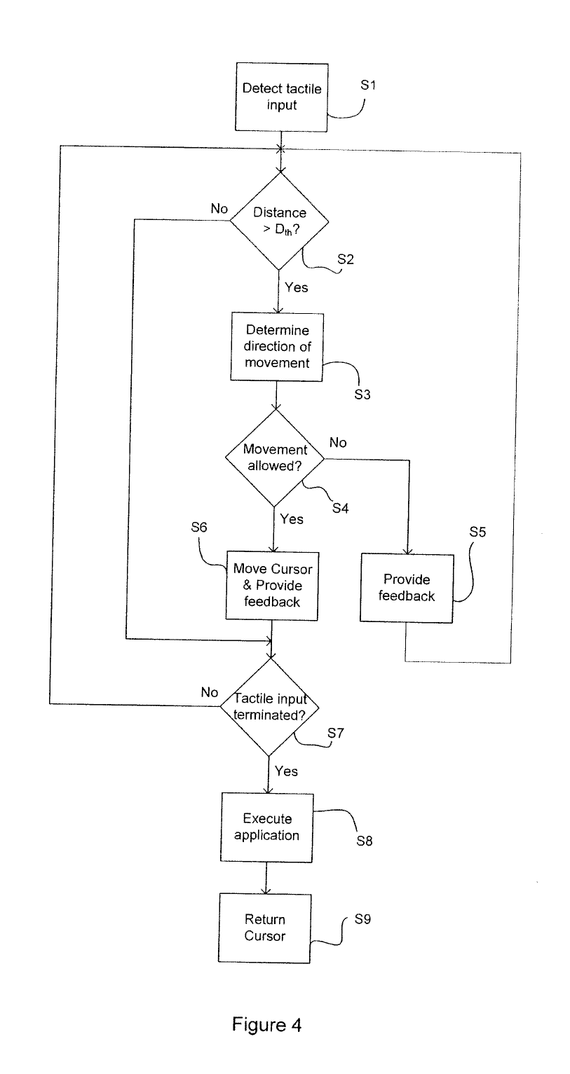

An exemplary operation of the electronic apparatus 1 of FIG. 1 will now be described with reference to the flowchart of FIG. 4. In step S1 the controller 14 determines, based on signals received from the touch-sensitive panel 12, that a tactile input is incident on the touch-sensitive panel 12.

Next, in step S2, the controller 14 determines if the tactile input is slid across the surface of the touch-sensitive panel 12 by a distance which is greater than a predetermined threshold. The threshold distance may be, for example, in the range of 5 to 20 millimeters. According to some exemplary embodiments, the threshold distance may correspond to the width or height of the icons 25 displayed on the array 24. The provision of a threshold distance may mean that small movements of a touch input, that may be accidental movements in what a user intended to be a stationary input, does not cause the indicator 26 to be moved, and that a deliberate dynamic tactile input is required in order to cause the indicator to be moved. If it is determined, in step S2, that the tactile input has moved by more than the threshold distance, the operation proceeds to step S3.

In step S3, the direction of movement of the tactile input is determined. Next in step S4, it is determined if movement of the indicator 26 in a direction corresponding to the direction of movement of the tactile input is allowed. Movement of the indicator 26 may not be allowed if for example, the movement is not along the allowed predetermined path 40, or if an indicator 26 is at an edge of the array 24 and the direction of movement is towards that edge.

If, in step S4, it is determined that a movement is not allowed, the operation proceeds to step S5, in which a non-visual signal indicating a disallowed movement is provided. The feedback may include a haptic signal provided by the vibration module 18, or an error sound being provided by the speaker 16. The operation then returns to step S2.

If, in step S4, it is determined that the movement is allowed, the operation proceeds to step S6. In step S6 the indicator 26 is caused to be moved from its current location to a neighboring icon 25 in a direction corresponding to the direction of movement of the dynamic tactile input. Also in step S6, a non-visual signal is provided to the user. The non-visual signal may include a haptic signal provided by the vibration module 18 and/or a sound provided by the speaker 16. In one example, the type of sound and/or the pattern of the haptic signal is dependent on the direction of movement of the indicator.

Next, in step S7 it is determined if the tactile input has been completed. Here, the controller 14 determines, based on signals received from the touch-sensitive panel 12, if the user has removed their finger 30 from the touch-sensitive panel 12.

If it is determined, in S7, that the tactile input has been terminated, the controller 14 causes in step S8 an action associated with the icon 25 on which the indicator 26 was provided immediately before completion of the tactile input to be executed or performed. Following performance of the action, in step S9, the indicator 26 is returned to its initial location. For example, if the example depicted in FIGS. 3A to 3D is considered, the indicator 26 would move back from the “7 key” to the original position, which in this example is the “5 key”. If the action associated with a particular icon 25 is such that the array 24 of icons 25 is caused to disappear, for example, because a program is launched, step S9 may not be necessary.

If, in step S2, it is determined that the tactile input has not moved by more than the predetermined threshold, the operation proceeds to step S7 in which it is determined if the tactile input has been completed. If it is determined that the tactile input has been completed, i.e. the user has removed their finger 30, an application associated with the icon 25 at the starting location of the indicator 26 is executed.

If, in step S7, it is determined that a tactile input has not been terminated the operation returns to step S2 in which it is determined if the tactile input has moved by a distance greater than the threshold distance. In this way, the user is able to cause the indicator 26 to be moved more than once using a single dynamic tactile input. The progression to step S7 on a ‘no’ result from step S2 allows the controller 14 to track the input until it either exceeds the distance threshold or else is terminated without exceeding the threshold.

The various steps of the above-described operation are performed by the one or more processors 14A of the controller 14, under the control of computer readable code, optionally stored on the non-transitory memory medium.

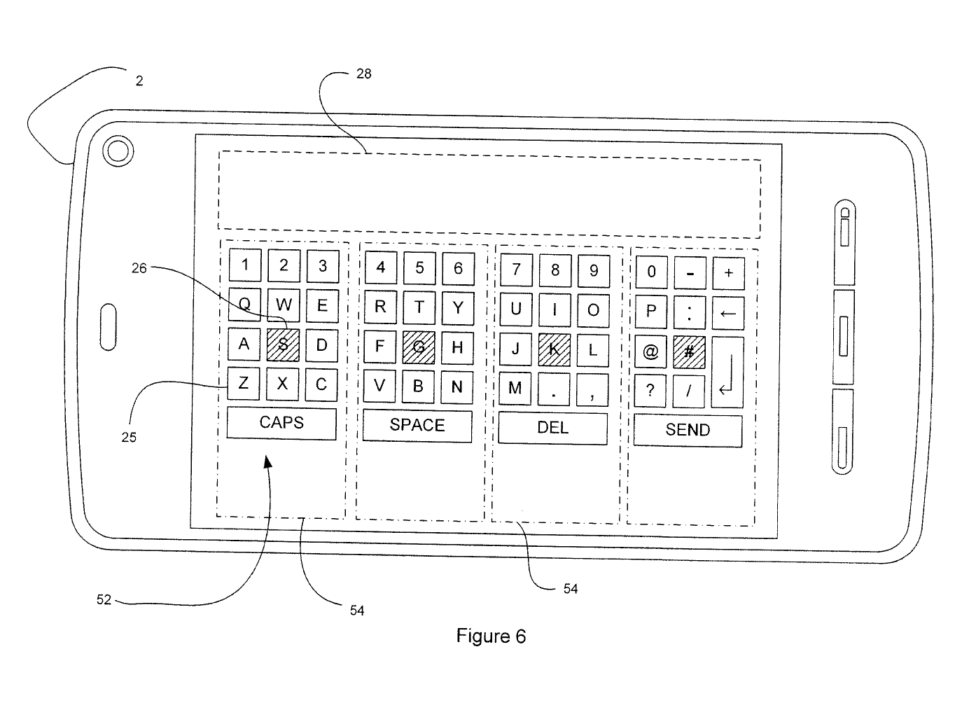

FIG. 6 shows the electronic device 2 of FIG. 2 according to alternative exemplary embodiments of the present invention. According to these embodiments, the touchscreen 10, 12 is required to display a larger number of icons 25 than are displayed in FIG. 2. The icons 25 are divided up into a plurality of arrays 52. In the example of FIG. 6, icons 25 representing the keys 22 of a computer keyboard are divided up into four arrays 52. Each of the arrays 52 is provided with an indicator 26 at the centermost icon 25 of the array. The indicator 26 is moveable about the array 24 as is described with reference to FIGS. 2, 3, 4 and 5.

The touch-sensitive panel 12 is divided up into a plurality of regions 54. Each region 54 corresponds to one of the plurality of arrays 52. Thus, in order to move the indicator 26 of a particular array, the user initiates the dynamic tactile input at a location within the region 54 corresponding to that array. The precise location within the region of the initiation of the dynamic touch input is not critical. The finishing point of the tactile input is not critical.

The operation of the device of FIG. 6 is substantially the same as that described with reference to FIG. 5, but includes an additional step between steps S1 and S2 of determining the identity of the selection region 54 to which the touch input is incident. Following this additional step the operation proceeds as described with reference to FIG. 5 with each of the steps being carried out in respect of the array 24 corresponding to the identified selection region.

According to other exemplary embodiments, the keys 25 of a keyboard may be divided into just two arrays, with the starting points of the two indicators 28 being located at, for example, the “D key” and the “K key” respectively. According to such embodiments, the touch-sensitive panel 12 is divided into two regions 54, each associated with a different one of the two arrays 52. These embodiments may be particularly suitable for allowing a user to operate the displayed keyboard using their two thumbs.

According to alternative exemplary embodiments, indicators 26 may not be displayed initially on each of the arrays 52. Instead, an indicator 26 may be displayed on an array 52 in response to receiving a touch input which starts in the region 54 of the touch-sensitive panel 12 corresponding to that array.

In each of the above described embodiments, the tactile input is provided by the user touching the touch-sensitive panel 12 with their finger 30. It will be understood however, that the tactile input may alternatively be provided by a stylus or in any other suitable way.

According to some exemplary embodiments, the touch sensitive panel 12 may be embedded in a mechanical or touch-sensitive keyboard.

Some examples of the above described methods and apparatuses may allow selectable icons that are displayed on the touch screen 10, 12 to be smaller in size. This is because in some examples the user does not necessarily have physically to touch an icon to select it, and so there is no requirement for the icons to be of a size such that the user is able to touch one icon without also touching neighboring icons. Also, because in some examples the user is not necessarily required to touch an icon to select it, the icons may not required to be so large that the user's finger does not entirely obscure the icon as the touch input is being provided. This may also allows the user to have better control during selection of icons, because the user's view is not obscured by their finger. In some examples the provision of smaller icons means that a greater number of icons may be displayed at one time.

Also, the above embodiments have been described with reference to an electronic device 2, in particular a mobile phone comprising a touchscreen 10, 12. However, the invention is also applicable to electronic devices including separate touch-sensitive panels 12 and display panels 10, such as laptops. The present invention may be particularly useful for use in controlling the onboard computer of a car. In such an example, the touch-sensitive panel 12 may be provided at a location on the steering wheel that is accessible without the driver needing to take their hands off the wheel. The indicator 26 may be provided for example on the car's dashboard. The audio signals resulting from movement of the indicator 26 may be provided via the audio system of the car. Because the user is able to learn to navigate throughout the array 24 without looking at the display, there may be no need for the driver to take their eyes off the road while controlling the onboard computer.

Some types of touch-sensitive panel, for example projected capacitive touch sensitive panels, are able to detect the presence of a finger, thumb or stylus proximate to, but not actually in contact with, the surface of the panel. Thus, according to some exemplary embodiments, the user may not be required actually to touch the surface of the panel, but instead can provide inputs to the panel when they are only proximate to it.

According to alternative embodiments, the array 24 of images or icons 25 may be moveable relative to the indicator 26. In these embodiments, a leftwards movement, for example, may cause the entire array 24 to be moved to the right relative to the indicator 26, which stays stationary. The highlighted image or icon 25 may for instance be surrounded by a circle or other graphic that remains at a position central to the display. In the embodiments the images or icons 25 may be provided in a continuous fashion, so that an edge of the array is not reached and instead the displayed images or icons loop around to the opposite side of the array.

It should be realized that the foregoing embodiments should not be construed as limiting. Other variations and modifications will be apparent to persons skilled in the art upon reading the present application. Moreover, the disclosure of the present application should be understood to include any novel features or any novel combination of features either explicitly or implicitly disclosed herein or any generalization thereof and during the prosecution of the present application or of any application derived therefrom, new claims may be formulated to cover any such features and/or combination of such features.

1. Apparatus comprising at least one processor configured, under the control of machine-readable code:
to receive from a touch sensitive transducer signals indicative of a detected dynamic tactile input incident on the touch sensitive transducer;
to determine based on the signals received from the touch sensitive transducer a direction of an initial movement of a detected dynamic tactile input; and
to provide control signals for causing an indicator, the indicator being for indicating to a user a currently highlighted one of an array of images displayed on a display panel, to be moved in a direction corresponding to the direction of the initial movement from a first image of the array of images to a second image of the array of images, the second image directly neighboring the first image, said indicator being moveable from a currently highlighted image to images directly neighboring the currently highlighted image.

2. The apparatus of claim 1, the at least one processor being further configured:
to determine based on the signals received from the touch sensitive transducer a direction of a secondary movement of the detected dynamic tactile input; and
to provide control signals for causing the indicator to be moved in a direction corresponding to the direction of the secondary movement from the second image to a third image, the third image directly neighboring the second image.

3. The apparatus of claim 1, the at least one processor being further configured to be responsive to determining that the dynamic tactile input has been completed to provide control signals for causing an action corresponding to the currently highlighted image to be performed.

4. The apparatus of claim 1, the at least one processor being configured to be responsive to determining that the dynamic tactile input has been completed to provide control signals for causing the indicator to be returned to the first image.

5. The apparatus of claim 1, wherein the first image is one of: a centermost image, and a one of plural jointly centermost images of the array.

6. The apparatus of claim 1, the at least one processor being configured to provide control signals for causing a non-visual output transducer to provide a non-visual signal to the user substantially as control signals are being provided for causing the indicator to be moved from one image to a neighboring image.

7. The apparatus of claim 6, the at least one processor being configured:
to provide control signals for causing the non-visual output transducer to provide non-visual signal of a first type substantially as control signals are being provided for causing the indicator to be moved in the first direction; and
to provide control signals for causing the non-visual output transducer to provide a non-visual signal of a second type substantially as control signals are being provided for causing the indicator to be moved in a different direction to the first direction,
wherein the first and second types of non-visual signal are different.

8. The apparatus of claim 6, the at least one processor being configured to be responsive to determining that the currently highlighted image is at an edge of the array and that the direction of movement of the dynamic tactile input is towards the edge of the array to provide control signals for causing the non-visual output transducer to provide non-visual signal to the user.

9. The apparatus of claim 1, wherein the indicator is moveable from the first image to another image along a single predetermined path and wherein other possible paths are prohibited.

10. The apparatus of claim 1, wherein the at least one processor is configured:
to determine, based on the signals received from the touch sensitive transducer, an identity of a region of the touch sensitive transducer, the touch sensitive transducer having a touch sensitive area divided into plural regions, each of the regions corresponding to a different one of a plurality of arrays of images being displayed on the display panel, each of the plural arrays of images including an indicator for indicating to the user a currently highlighted one of the array of images of the respective array, said indicator being moveable from a currently highlighted image to images directly neighboring the currently highlighted image,
wherein the control signals for causing the indicator to be moved are for causing the indicator of the array corresponding to the identified region of the touch sensitive area to be moved from a first image in the array to a second image in the array, wherein the second image in the array directly neighbors the first image in the array.

11. A method comprising:
receiving from a touch sensitive transducer signals indicative of a detected dynamic tactile input incident on the touch sensitive transducer;
determining, based on the signals received from the touch sensitive transducer, a direction of an initial movement of the detected dynamic tactile input;
providing control signals for causing an indicator, the indicator being for indicating to a user a currently highlighted one of an array of images displayed on a display panel, to be moved in a direction corresponding to the direction of the initial movement from a first image in the array of images to a second image in the array of images, the second image directly neighboring the first image, said indicator being moveable from a currently highlighted image to images directly neighboring the currently highlighted image.

12. The method of claim 11, further comprising:
determining, based on the signals received from the touch sensitive transducer, a direction of a secondary movement of the detected dynamic tactile input; and
providing a control signal for causing the indicator to be moved in a direction corresponding to the direction of the secondary movement from the second image to a third image of the array of images, the third image directly neighboring the second image.

13. The method of claim 11, further comprising:
in response to determining, based on the signals received from the touch sensitive transducer that the dynamic tactile input has been completed, providing a control signal for causing an action corresponding to the currently highlighted image to be performed.

14. The method of claim 11, further comprising:
in response to determining, based on the signals received from the touch sensitive transducer, that the dynamic tactile input has been completed, providing a control signal for causing the indicator to be returned to the first image.

15. The method of claim 11, further comprising:
providing to a non-visual output transducer a control signal for causing the non-visual output transducer to provide a non-visual signal to the user substantially simultaneously to providing the control signal for causing the indicator to be moved from one image in the array to a neighboring image in the array.

16. The method of claim 15, further comprising:
providing to the non-visual output transducer a control signal for causing the non-visual output transducer to provide a first type of non-visual signal to the user substantially simultaneously to providing the control signal for causing the indicator to be moved in the first direction; and
providing to the non-visual output transducer a control signal for causing the non-visual output transducer to provide a second type of non-visual signal to the user substantially simultaneously to providing a control signal for causing the indicator to be moved in a different direction to the first direction, wherein the first and second types of non-visual signal are different.

17. The method of claim 15, further comprising in response to determining that the currently highlighted image is at an edge of the array and that the direction of movement of the dynamic tactile input is towards the edge of the array, providing to the non-visual output transducer a control signal for causing the non-visual output transducer to provide non-visual signal to the user.

18. The method of claim 1, further comprising:
determining, based on the signal received from the touch sensitive transducer, an identity of a region of the touch sensitive transducer, the touch sensitive transducer having a touch sensitive area divided into plural regions, each of the regions corresponding to a different one of a plurality of arrays of images being displayed on the display panel, each of the plural arrays of images including an indicator for indicating to the user a currently highlighted one of the array of images of the respective array, said indicator being moveable from a currently highlighted image to images directly neighboring the currently highlighted image,
wherein the control signals for causing the indicator to be moved are for causing the indicator of the array corresponding to the identified region of the touch sensitive transducer to be moved from a first image in the array to a second image in the array, wherein the second image in the array directly neighbors the first image in the array.

19. A non-transitory computer-readable storage medium having stored thereon computer-readable code, which, when executed by computer apparatus, causes the computer apparatus:
to receive from a touch sensitive transducer signals indicative of a detected dynamic tactile input incident on the touch sensitive transducer;
to determine, based on the signals received from the touch sensitive transducer, a direction of an initial movement of the detected dynamic tactile input; and
to provide control signals for causing an indicator, the indicator being for indicating to a user a currently highlighted one of the array of images displayed on a display panel, to be moved in a direction corresponding to the direction of the initial movement from a first image in the array of images to a second image in the array of images, the second image directly neighboring the first image, said indicator being moveable from a currently highlighted image to images directly neighboring the currently highlighted image.
